(19) United States
(12) Patent Application Publication
(10) Pub. No.: US 2010/0066529 A1
(43) Pub. Date: Mar. 18, 2010

(54) Highly intelligent vehicle with brake light repeater

(76) Inventors: Walton P. Haines, Corralitos, CA (US); Donald F. Rode, Sunnyvale, CA (US)

Correspondence Address: Walton P. Haines, President;Interjacent Technologies Systems Inc., 747 Haines Ranch Rd., Corralitos, CA, 95076-0116, US

(21) Appl. No.: 12/590,762

(22) Filed: Nov. 13, 2009

Related U.S. Application Data
(63) Continuation-in-part of application No. 12/287,635, filed on Oct. 9, 2008.
(60) Provisional application No. 60/998,418, filed on Oct. 9, 2007.

(51) Int. Cl. B60Q 1/44

(52) U.S. Cl. 340/479

(57) ABSTRACT

An improved brake light warning system is provided that warns the driver of an intelligent vehicle of the need to brake while simultaneously alerting the driver of a following car prior to the driver of the intelligent vehicle stepping on the brakes. A highly intelligent vehicle processor monitors inputs from various sources and compares the reactions of the driver of the highly intelligent vehicle to that of a virtual competent driver in the same context. In response to the presence of an obstacle, the leading car may brake or decelerate. The highly intelligent vehicle detects the response of the leading car via a remote sensing device, determines a context from the physical data, determines what the virtual competent driver would do, determines if the driver should brake, and sends a warning signal to the driver. In one embodiment, a pre-brake signal is also sent to the brake light assembly. The brake light assembly illuminates and is observable by the driver of the following car. Other unsafe conditions are determined in other embodiments. Trip reports regarding unsafe conditions, vehicle context, virtual competent driver actions, recommended driver actions, and warning signals are generated and may be used to improved driver safety.

### RELATED APPLICATIONS

This application is a continuation-in-part of, and claims priority based on, co-pending U.S. patent application Ser. No. 12/287,635, filed Oct. 9, 2008, entitled “Brake Light with Pre-brake Warning.” This application and the parent application claim priority under 35 U.S.C. §199(e) of U.S. provisional application Ser. No. 60/998,418, filed Oct. 9, 2007.

### BACKGROUND OF THE INVENTION

1. Field of Invention

This invention relates to intelligent vehicles, specifically to an improved intelligent vehicle with a virtual competent driver and brake light repeater.

2. Prior Art

For many years, vehicles have had brake lights that illuminated to warn a following vehicle that the braking vehicle was going to stop. Originally, brake lights were separate light bulbs with a discrete colored lens. Next, brake lights where incorporated into break light assemblies that had brake indicator, turn indicators, and sometimes reverse indicators. More recently, computers and data buses have been incorporated into vehicles and the brake light assembly is controlled by a computer-based microcontroller. When a brake signal is sent across the vehicle data bus, the microcontroller associated with the brake assembly illuminates the brake indicator.

There has been a long felt need for more intelligent vehicles that increase vehicle safety. Interjacent Technology Systems of Corralitos, Calif. has developed an expert system called the Interjacent Trip Processor, which can be added to a vehicle data bus to provide a highly intelligent vehicle. See Appendix A for more information.

What is needed is a highly intelligent vehicle that aids that vehicle's driver in being a safer driver. There also is still a need to alert the driver of a need to brake, and to alert the following driver that the intelligent vehicle has detected a need to brake, before the driver of highly intelligent vehicle actually breaks.

### SUMMARY

In accordance with one embodiment, this invention can prevent a significant number of rear end collisions if a following driver received an indication of a need to brake a fraction of a second sooner. A highly intelligent vehicle processor that monitors a variety of inputs could detect the need for the driver to brake by comparing the driver's reaction to that of a virtual competent driver in the same context. Alternatively, the highly intelligent vehicle processor could observe the deceleration of one or more vehicles ahead, using radar or Lidar. Prior to the driver actually stepping on the brake and sending the convention brake signal to the brake indicator, the highly intelligent vehicle processor sends a warning signal to the driver and to the brake light assembly.

### OBJECTS AND ADVANTAGES

Accordingly, the present invention includes the following advantages:
a) Providing a faster and more reliable means of alerting drivers of a highly intelligent vehicle of the need to brake in response to an obstacle, hazard, or decelerating vehicle ahead.
b) Reducing the number of head-on collisions caused by driver inexperience or inattention by providing an improved system of alerting the driver of obstacles and/or hazards ahead.
c) Providing a two-fold alert system that notifies both the driver of the intelligent vehicle system and a following vehicle of the need to brake in response to obstacles and/or hazards ahead.
d) Providing a system that can be used on various types of transportation vehicles, including but not limited to buses and semi-trailer trucks.
e) Providing a pre-brake warning system that is easily installed in both new and old vehicles (as an after-market add-on).
f) Reducing congestion by providing a safe early alert system that increases the amount of time a driver has to react to hazards ahead.
g) Increasing the driver's comfort level in high traffic situations.

### DRAWINGS—FIGURES

FIG. 1 shows the cross-section of a highly intelligent vehicle with a brake warning system.

FIG. 2 shows a brake light assembly.

FIG. 3 shows a simplified embodiment of a vehicle with a driver warning.

FIG. 4 shows a sequence of cars responding to an obstacle.

FIG. 5 is a flow chart showing an embodiment of an algorithm for the brake warning system.

### REFERENCE NUMERALS

100 brake light assembly

111 pre-brake signal

112 brake signal

113 reverse signal

120 brake indicator

122 brake switch

123 reverse switch

130 reverse indicator

140 virtual competent driver

150 highly intelligent vehicle

160 transmission

162 gear shift

170 remote sensing device (e.g. radar, LIDAR)

180 driver

190 driver warning

230 turn indicator

300 processor

400 obstacle

410 leading car

420 following car

510 start

512 monitor inputs

514 determine context

516 determine virtual reaction

518 driver reaction the same?

520 continue path

522 braking required?

524 no action path

526 send warning signal

528 warning state path

### DETAILED DESCRIPTION

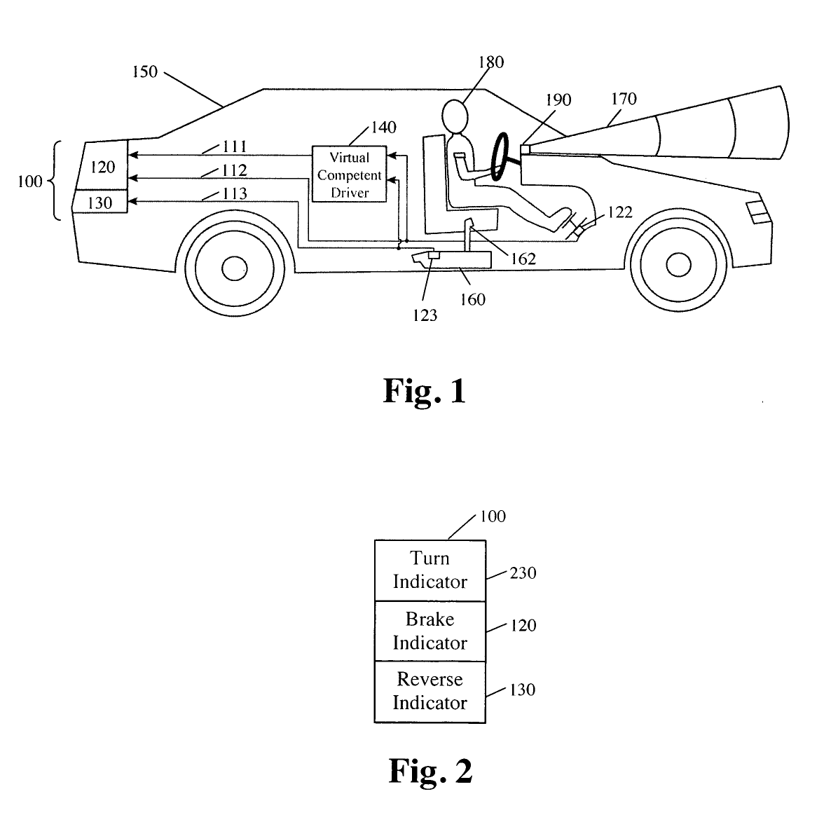

FIG. 1 shows the cross-section of an intelligent vehicle 150 equipped with a remote sensing device 170 (based on RADAR, LIDAR, etc.), a Virtual Competent Driver 140, and a brake light assembly 100. The brake light assembly 100 comprises a brake indicator 120 and a reverse indicator 130. The vehicle also has a brake pedal with a brake switch 122, and a transmission with a gear shift 162 and a reverse switch 123.

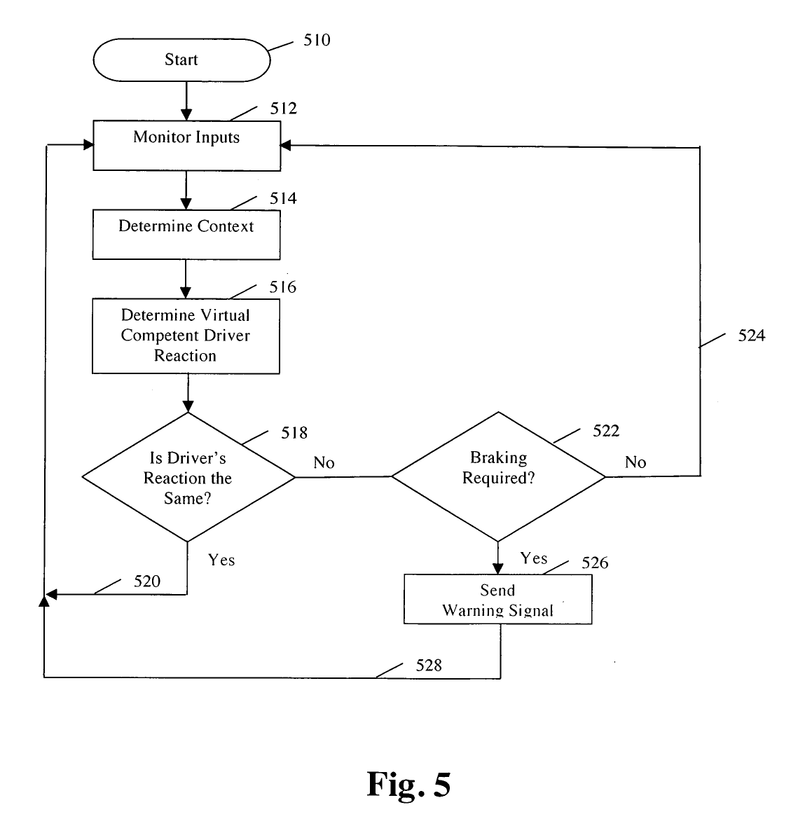

A highly intelligent vehicle processor monitors inputs (FIG. 5, step 512) from a variety of sources—including but not limited to the brake switch 122, the reverse switch 123, the transmission 160—and compares the reactions of the driver 180 of the highly intelligent vehicle (FIG. 5, step 518) to that of a virtual competent driver 140 in the same context (FIG. 5, steps 514 and 516). The virtual competent driver 140 can be implemented as a software program, such as the Interjacent expert system. Before the driver 180 steps on the brake switch 122 (FIG. 5, step 522), sending a conventional brake signal 112 to the brake indicator 120, the highly intelligent vehicle processor sends a pre-brake signal 111 to the brake light assembly 100. A driver warning 190 is also sent to the driver (illustrated as an indicator on the dash board of the highly intelligent vehicle 150) (FIG. 5, step 526).

FIG. 2 illustrates a brake light assembly 100. The brake light assembly 100 comprises a brake indicator 120, a reverse indicator 130, and a turn indicator 230.

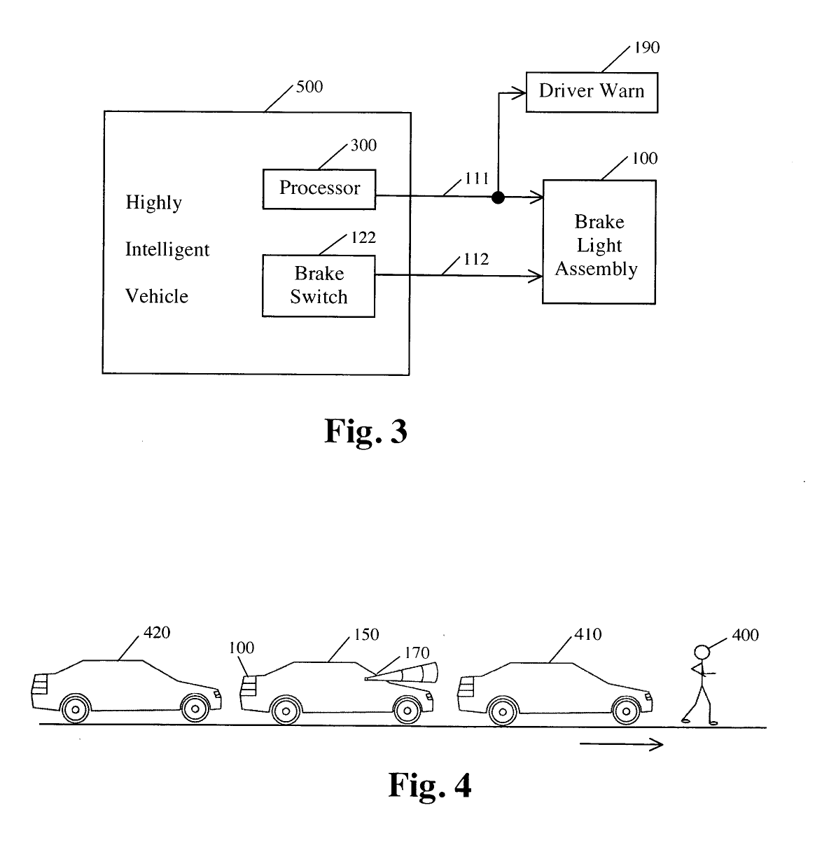

A simple embodiment of the driver warning system is shown in FIG. 3. In this embodiment a highly intelligent vehicle comprises at least a processor 300 and a brake switch 122. The processor 300 sends a pre-brake signal 111 to the brake light assembly 100 and driver warning 190. The brake switch 122 sends a brake command 112 to the brake light assembly 100.

FIG. 4 shows a sequence of vehicles responding to obstacle 400. Upon detecting the presence of obstacle 400, the leading car 410 may respond by either braking or decelerating (with wheel brakes or with engine breaking). The highly intelligent vehicle 150 detects the response of the leading car 410 via a remote sensing device 170 (FIG. 5, steps 512, 514, 516) and sends a pre-brake signal 111 (FIG. 5, step 526) to the brake light assembly 100. In turn, the brake light assembly 100 illuminates and is observable by the driver of following car 420. In this way the driver of the following car 420 is alerted even before the driver of the highly intelligent vehicle presses the brake pedal.

At the same time that the pre-brake signal 111 is sent the driver warning 190 (as shown in FIG. 3) is also activated. The driver warning 190 could be a visual indicator, audio indicator, or both. The driver warning 190, or the deceleration of the leading car 410, will eventually be noticed by the driver of the highly intelligent vehicle 150 who will then hit the brake pedal. When brake pedal of vehicle 150 is hit, the brake light assembly 100 will continue to illuminate until the break pedal is released (FIG. 5, warning state 528).

Thus, in this scenario with this embodiment, the following driver will be given valuable seconds to respond and avoid a collision and its result damage and injury.

Various embodiments of novel brake light assemblies are shown in the parent application.

FIG. 5 is a flow chart illustrating a method aspect of the brake warning system. The method starts a 510. At step 512, the system monitors current inputs for various input devices including remote sensing devices 170 (such as RADAR, LIDAR, or video). Next, at step 514, the system determines the context that the vehicle is in for example in relation to other vehicles (e.g. 410, 420) or other obstacles 400, as well as vehicle location/direction (e.g. via GPS and digital maps), linear speed, wheel rotation speeds, and current driver's actions (e.g. turn signaling 230, braking 122, shifting 162, reversing 123, etc.) Next, the processor 300 determines, at step 516, what the virtual competent driver 140 would do. At decision 518, the system determines if the driver's reaction is the same as the virtual competent driver 140, if it is, then flow continues along path 520 back to the monitor inputs step 512.

If at decision 518, the system determines that the driver's reaction is not the same as the virtual competent driver 140, flow continues to decision 522. At decision 522, the system determines if braking is required. If not, flow continues along no action path 524. (In other embodiments other types of actions could also be evaluated such as whether or not lane change would be advised—see Appendix A). If braking is required, then at step 526 the system sends a warning signal (111, 190), and flow continues in a warning state along path 528 back to step 512.

### ADDITIONAL EMBODIMENTS

In some embodiments the warning system will store current physical data, vehicle context, determined unsafe conditions, virtual competent driver actions, recommended driver actions, and warning signals. One of more of these may be reported in a trip report.

In one embodiment, trip reports are generated for the semi-trailer trucks of a trucking company, and are transmitted to the trucking company to evaluate and improve truck driver safety.

Other types of trip reports could be used for bus, train, or other vehicles.

### CONCLUSION, RAMIFICATION, AND SCOPE

Accordingly, the reader will see that the improved intelligent vehicle with a virtual competent driver and brake light repeater will increase driving safety and significant reduce damage to vehicles and occupants of those vehicles.

While the above descriptions contain several specifics these should not be construed as limitations on the scope of the invention, but rather as examples of some of the preferred embodiments thereof. Many other variations are possible. For example, different types of expected driver actions could be determined and recommended by the driver warning system. Further, in the brake warning state other steps could be added, for example, if the driver brakes the warning indicator could be turned off. Further, some of these novel concepts are not limited to cars, trucks, and buses but could be used in other types of vehicles such as trains and airplanes. The variations could be used without departing from the scope and spirit of the novel features of the present invention.

Accordingly, the scope of the invention should be determined not by the illustrated embodiments, but by the appended claims and their legal equivalents.

What is claimed is:

1. In a highly intelligent vehicle, a method of warning a driver of an unsafe condition, comprising the steps of:
a) monitoring physical data from a plurality of inputs,
b) determining a context of the highly intelligent vehicle, including determining a current one of a plurality of predetermined unsafe conditions,
c) determining a reaction of a virtual competent driver in the context,
d) determining an action that the vehicle driver should take,
e) sending a warning signal of the current unsafe condition,
wherein vehicle safety is improved.

2. The method of claim 1, where the determined action is to brake and the warning signal is a driver brake warning signal.

3. The method of claim 2, wherein the warning signal is sent to a brake light assembly.

4. The method of claim 1, where the determined action is to change lanes.

5. The method of claim 1, where the physical data is from at least one remote sensing device.

6. The method of claim 5 wherein the remote sensing device is a video camera.

7. The method of claim 5 wherein the remote sensing device is RADAR.

8. The method of claim 5 wherein the remote sensing device is LIDAR.

9. The method of claim 1, where the physical data is GPS data providing a current location.

10. The method of claim 9, where the GPS data is correlated to a digital map.

11. The method of claim 9, where the GPS data provides ground speed and direction.

12. The method of claim 1, where the physical data is one of:
a) linear speed, and
b) wheel rotation speed.

13. The method of claim 1, where the physical data is one of:
a) turn signal data,
b) brake switch data,
c) gear shift data, and
d) reverse data.

14. The method of claim 1, where the unsafe condition is an obstacle entering the path of the vehicle.

15. The method of claim 1, wherein the obstacle is a person.

16. The method of claim 1, wherein the obstacle is another vehicle.

17. The method of claim 1, where the unsafe condition is one or more vehicles slowing or stopping in front of the highly intelligent vehicle.

18. The method of claim 1, where the unsafe condition is the speed of the intelligent vehicle being inconsistent with the speed of the surrounding vehicles.

19. The method of claim 1, further comprising a step of generating a report containing at least one of:
a) the current unsafe condition,
b) the current context including the physical data,
c) the current virtual driver reaction,
d) the recommend driver action, and
e) the current warning signal.

20. In a highly intelligent vehicle, a driver warning system comprising:
a) a plurality of inputs comprising at least one remote sensing device input,
b) a processor, wherein the processor:
i) determines, from the plurality of inputs, a context of the highly intelligent vehicle, including a one of a plurality of predetermined unsafe conditions,
ii) determines a reaction of a virtual competent driver in the context,
iii) determines an action that a vehicle driver should take,
c) at least one output signal corresponding to the one of a plurality of predetermined unsafe conditions,
whereby the vehicle driver is warned of the current unsafe condition by the corresponding output signal.
